(19) United States
(12) Patent Application Publication
(10) Pub. No.: US 2015/0294416 A1
(43) Pub. Date: Oct. 15, 2015

(54) Use of Trade Frequency in the Detection of Multi-Order Market Abuse

(71) Applicant: FIDESSA CORPORATION, New York, NY (US)

(72) Inventors: Bruce Bland, Chesham (GB); Daniel Nicholass, Wallington (GB)

(73) Assignee: FIDESSA CORPORATION, New York, NY (US)

(21) Appl. No.: 14/437,793

(22) PCT Filed: Mar. 15, 2013
(86) PCT No.: PCT/US13/32400

§ 371 Date: Apr. 22, 2015

Related U.S. Application Data
(60) Provisional application No. 61/718,334, filed on Oct. 25, 2012.

(51) Int. Cl. G06Q 40/04

(52) U.S. Cl. CPC G06Q 40/04

(57) ABSTRACT

Techniques for detecting multi-order market abuse in the trading of financial instruments using a direct market access gateway adapted to communicate an order from a client to an exchange. One or more memories are adapted to store a plurality of trade orders for a financial instrument placed by the client and corresponding arrival times of each order. One or more processors are configured to process the stored arrival times of each of the plurality of trade orders to determine an average time between orders for a trade sequence, and are configured to generate information about the at least one trade sequence. The information about the trade sequence is output if the average time between orders is less than a predetermined percentage of a characteristic trade frequency of the financial instrument.

### CROSS-REFERENCE TO RELATED APPLICATIONS

This application is related to U.S. Provisional Application Ser. No. 61/718,334, filed Oct. 25, 2012, which is incorporated herein by reference in its entirety and from which priority is claimed.

### BACKGROUND

The disclosed subject matter relates to techniques for the management of the trading of financial instruments, and more particularly to techniques for detecting multi-order market abuse.

In the trading of financial instruments, including, e.g., equities, options, futures, derivatives, or the like, market regulations can require any organization providing market access to perform compliance checks against incoming client order flow to detect potential market abuse situations. Regulatory schemes such as the Dodd Frank Act, the Market Abuse Directive (MAD), the Markets in Financial Instruments Directive (MiFID), and the European Securities and Markets Authority (ESMA) Guidelines 2012/122 impose certain requirements on those involved in the trading of financial instruments. For example, the ESMA guidelines provide that firms engaged in proprietary trading and those offering direct market access (DMA) take efforts to monitor and report on trading activities performed by their clients to detect market abuses.

Certain market abuse scenarios can be based on single orders. For example, a trader seeking to influence the price of a financial instrument may buy or sell qualifying investments at the close of the market with the effect of misleading investors who act on the basis of closing prices. Additionally, traders may act in concert to buy and sell financial instruments where the transfer of beneficial interest or market risk is only between colluding parties for other than legitimate reasons. Such market abuses can be detected using certain known techniques, which can generally involve real-time monitoring of orders and identifying a potential abuse based on predetermined trade characteristics, such as order size and/or the timing of the order.

Certain market abuse scenarios can be based on multiple orders by a single party (“multi-order market abuse”). Such scenarios can involve the placing of multiple orders in an effort to affect the price of a financial instrument. With the advent of algorithmic and/or automated trading, including high frequency trading (HFT), the volume of order flow messages can be high. High message volume can create difficulties in the monitoring and surveillance of order flow for market abuse detection purposes. Real-time detection of market abuse amid high volume order flow can be important to prevent market abuse and to prevent liability arising from noncompliance with regulations and requirements.

Accordingly, there is a need for improved techniques for detection \of market abuse.

### SUMMARY

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

To achieve these and other advantages and in accordance with the purpose of the disclosed subject matter, as embodied and broadly described, the disclosed subject matter includes enhanced techniques for the management of the trading of financial instruments, and more particularly to techniques for detecting multi-order market abuse.

In one aspect of the disclosed subject matter, techniques for detecting multi-order market abuse in the trading of financial instruments via a direct market access gateway adapted to communicate an order for a client to an exchange can include monitoring a plurality of trade orders for a financial instrument placed by the client. At least the arrival time of each of the plurality of trade orders is recorded and stored in one or more memories. The recorded arrival times are processed to determine an average time between orders for at least one trade sequence within the plurality of trade orders. Information about the trade sequence is output if the average time between orders is less than a predetermined percentage of a characteristic trade frequency of the financial instrument.

As embodied herein, the characteristic trade frequency of the financial instrument can include the average trade frequency of the financial instrument on the exchange. In one exemplary embodiment, if the average time between trade orders in the sequence is less than five percent of the average trade frequency, information about the sequence can be output. The output information can include a score corresponding to a likelihood of multiple order market abuse. The multiple order market abuse can be one or more of ramping or spoofing and layering.

The techniques disclosed herein can further include recording a limit price of each of the plurality of trade orders and processing the recorded limit prices to determine a correlation coefficient between the limit prices and the recorded arrival times of the trade orders. Additionally, the techniques disclosed herein can include recording a fraction of order volume filled for the order sequence. Moreover, the techniques disclosed herein can include recording processing the difference in percentage volume filled for the final order in the sequence relative to other orders in the sequence to generate an imbalance metric.

In another aspect of the disclosed subject matter, the techniques disclosed herein can be embodied in computer hardware and software. The included computer hardware can include at least, e.g., one or more computer processors communicatively coupled to one or more memories which store computer-readable instructions and trade processing information. Moreover, methods of the presently disclosed subject matter can be embodied as a computer readable medium storing executable code, which when executed can cause one or more processors to perform the functions disclosed herein. Alternatively, all or portions of the methods disclosed herein can be embodied in hard-wired circuitry, alone or in connection with executable code.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the disclosed subject matter. Together with the description, the drawings serve to explain the principles of the disclosed subject matter.

### BRIEF DESCRIPTION OF THE DRAWINGS

FIG. 1A is a schematic diagram of a system for providing a client market access to an exchange through a broker-dealer.

FIG. 1B is a schematic diagram of a system for providing a client sponsored direct market access to an exchange.

FIG. 2 is a schematic diagram of a system for detecting multi-order market abuse in accordance with an exemplary embodiment of the disclosed subject matter.

FIG. 3 is a flowchart of a method for detecting multi-order market abuse in accordance with an exemplary embodiment of the disclosed subject matter.

Throughout the drawings, the same reference numerals and characters, unless otherwise stated, are used to denote like features, elements, components or portions of the illustrated embodiments. Moreover, while the disclosed subject matter will now be described in detail with reference to the figures, it is done so in connection with the illustrative embodiments.

### DETAILED DESCRIPTION

The presently disclosed subject matter provides techniques for detecting multiple order market abuse, and in particular provides techniques for detecting multiple order market abuse in a direct market access gateway by a client transmitting trade orders to an exchange. As disclosed herein, an instrument's characteristic trade frequency can be used to determine if orders placed by the client are close enough in time to affect the market. Such techniques can be used to detect market abuse to satisfy regulatory requirements imposed on brokers and other entities providing market access to an exchange.

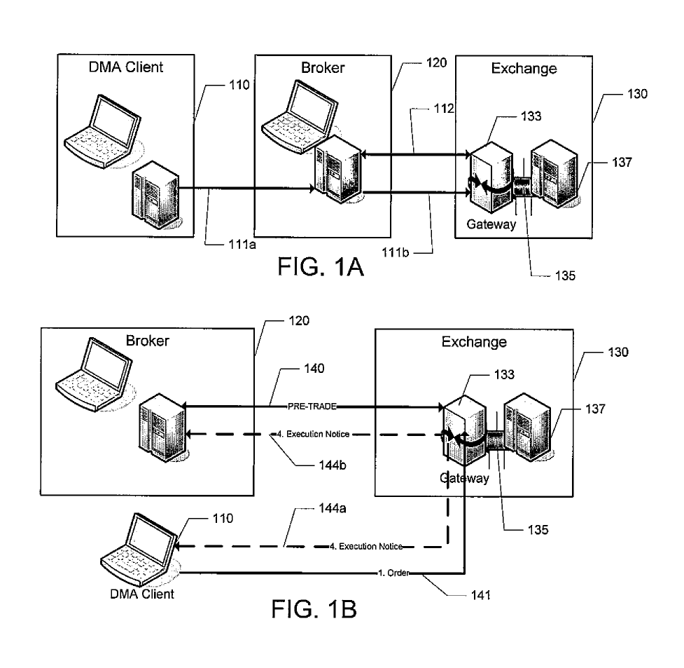

With reference to FIG. 1A and FIG. 1B, for purpose of illustration, and not limitation, traders, whether or not they are affiliated with registered broker-dealers, engaged in electronic trading typically utilize software products through which the user can obtain market price data and can enter and route their orders. With respect to traders employed by broker-dealers, these orders can represent either their own proprietary interest or be received, entered and routed on behalf of customers. In addition, broker-dealers can execute customer orders out of proprietary accounts.

With respect to third party traders 110, orders can be placed through a broker's system 120 as depicted in FIG. 1A. In such a scenario, the orders (111a and 111b) are typically cleared by the broker such that the broker bears financial responsibility for the trader's activity. For example, a trader 110 can send a trade message including details of a trade order 111a to the broker's system 120, which can then process the order and send a trade message 111b to a gateway 133 coupled with one or more servers 137 of an exchange 130. The exchange's servers 137 can include, for example, a trade engine adapted to execute the trade order. The gateway 133 can be adapted to communicate information 112 back to the broker 120, including the details of the trade such that the broker 120 can monitor and/or record trade activity.

The gateway 133 can be operated by, for example, a broker-dealer 120 providing market access to a client (e.g., trader 110), or alternatively can be operated by the exchange 130. The gateway 133 can include hardware and software for communicating via a network with one or more computing devices operated by the client 110, broker 120, and/or the exchange 130. The network can be, for example, the internet or a public or private intranet, and may be wired and/or wireless. In an exemplary embodiment, the network can be a dedicated network for the purpose of trading financial instruments. The gateway 133 can have one or more transmitters or receivers configured to send data over the network, such as one or more modems, routers, access points, switches, or the like. For purpose of illustration, communication between the gateway 133 over the network can be in accordance with a known protocol, such as Financial Information eXchange (FIX). Additionally or alternatively, communication over the network can be in accordance with the ISO 15000 series of specifications, Swift, or any other suitable message format. In this manner, trade orders can be placed by the client via the gateway 120 to the exchange for the purpose of trading one or more financial instruments.

Alternatively, with reference to FIG. 1B, traders 110 can place orders directly to an exchange via the Direct Market Access (DMA) gateway 133. The DMA can be operated, for example, by the broker 120 or the exchange 130. The trader 110 can place orders using the broker's market identifier, such that the broker 120 “sponsors” the trader's 110 access. The broker 120 and the gateway 133 can communicate pre-trade risk management information 140 prior to execution of a trade by the trader 110. The trader 110 can place an order 141 directly to the DMA gateway 133, which can then communicate with the exchange server 137, e.g., via data link 135, to execute the order. The gateway 133 can then send an execution notice 144a directly to the trader 110 indicating the order status. Additionally, the gateway 133 can send an execution notice 144b to the broker 120. The broker 120 may ultimately clear the orders and retain financial responsibility and/or be subject to regulatory requirements that require risk controls be implemented. As such, as noted above, certain regulatory schemes can require that broker 120 engaged in proprietary trading and those offering direct market access (DMA) take efforts to monitor and report on trading activities performed by their clients, e.g., trader 110, to detect market abuses. Thus, enhanced techniques for market abuse can not only provide compliance with applicable regulations, but also reduce financial risk and potential liability.

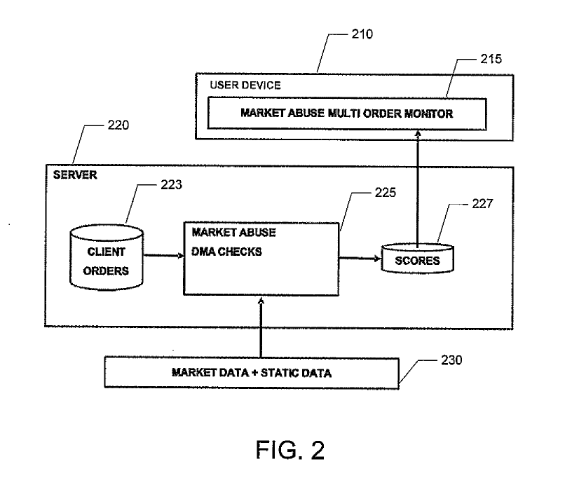

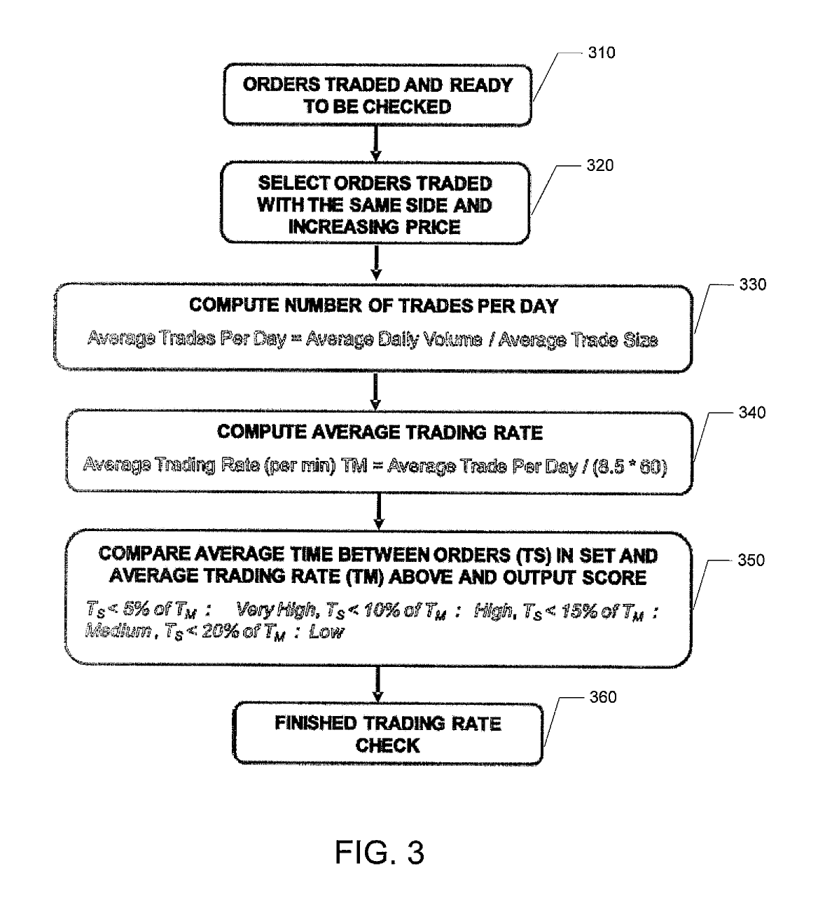

In an exemplary embodiment of one aspect of the disclosed subject matter, with reference to FIG. 2 and FIG. 3, techniques for detecting multi-order market abuse can include using an instrument's characteristic trade frequency to determine if orders are close enough in time to affect the market. A plurality of trade orders for a financial instrument (including, but not limited to, equities, options, futures, derivatives, or any other traded financial instrument) placed by a client can be monitored 310 and stored in one or more memories 223. As embodied herein, the memories 223 can include non-transitory computer readable storage media, including, without limitation, random access memory (RAM) such as dynamic RAM (DRAM) or static RAM (SRAM), read-only memory (ROM), erasable programmable read-only memory (EPROM), electrically erasable programmable read-only memory (EEPROM), non-volatile RAM (NVRAM), a CD-ROM, DVD, Magnetic disk, or the like. Moreover, as used herein, the term “memory” or “memories” can include one or more databases.

The client, such as a third party trader, can be given access to a DMA gateway as described above, which can be adapted to communicate orders 230 from the client to the exchange. As used herein, the term “exchange” can include any suitable market or exchange, such as the New York Stock Exchange, NASDAQ Stock Market, Chicago Mercantile Exchange, and other U.S. and foreign exchanges that trade stocks, commodities, swaps, currencies, and/or futures contracts. As described herein, and as will be appreciated by one of ordinary skill in the art, the plurality of trade orders placed by the client 230 can be routed through a broker or can be sent directly to the DMA gateway in a sponsored access arrangement. Accordingly, the trader orders can be monitored 310 with one or more processors and stored in the one or more memories 223 by, without limitation, one or more servers or computer systems operated by the broker and/or one or more servers operated by the exchange. Moreover, the trade orders can be monitored 310 and stored in the one or more memories 223 by the DMA gateway. That is, each of the client, the broker, and the exchange can include one or more of a server, a cluster of servers, a distributed computing system, or a cloud based computing system, each including one or more memory devices, databases, and/or computer readable media and adapted to execute the techniques disclosed herein.

For each trade order, one or more processors can record in the one or more memories 223 an arrival time of each of the plurality of trade orders. The one or more processors can be configured to process the recorded arrival times of each of the plurality of trade orders. For example, executable code for processing the trade orders 225 and detecting market abuse can be stored in the one or more memories, which can be coupled with one or more processors, such that when executed the code causes the one or more processors to perform the techniques disclosed herein. In particular, the one or more processors can be configured to process the arrival time of each of the plurality of trade orders to determine an average time between orders for at least one trade sequence within the plurality of trade orders. If average time between trade orders for the sequence is less than a predetermined percentage of a characteristic trade frequency of a particular financial instrument, the one or more processors can be configured to output information about the trade sequence.

As disclosed herein, orders traded with the same price and increasing price can be selected 320. The average number of trades per day for a financial instrument can be determined 330. For example, the average trades per day can be determined by dividing the average daily volume by the average trade size. The characteristic trade frequency (e.g., the average trade rate) for a financial instrument can be determined 340, for example by dividing the average trades per day by the number of minutes in a trading day. The average time between orders placed by a trader can be compared with the average trading rate 350 as described herein, and if the average time between trade orders in the sequence is less than a percentage of the characteristic trade frequency for the financial instrument, information about the sequence can be output 360. For example, if the average time between trade orders is less than five percent of the average trade rate, information about the sequence, such as one or more scores 127 corresponding to a likelihood of market abuse, can be output. Outputting such information can include, for example, sending information to a user-operated computer 210 adapted to monitor multiple order market abuse 215. The computer 210 can be configured to facilitate compliance with regulatory requirements where potential market abuse has been detected. For example, a user of the computer 210 may be require to submit a form or other information to the appropriate regulatory agency.

For purposes of illustration, and not limitation, an agent may attempt to move the market to their advantage by placing orders at a high enough frequency to overcome the actions of other agents. For example, if a single agent is entering orders at a frequency faster than the rest of the market combined, these orders could potentially affect the market. Thus, as disclosed herein, multi-order market abuse can include using an instrument's trade frequency for detection of time-clustered orders from a single client. The systems and methods disclosed herein can be employed in real-time, and can provide a dynamic measure of how rapidly a given market instrument trades. This can provide for detection algorithms to deal with groups of orders on an equal footing without having to correct for inter-instrument variations in activity.

The techniques disclosed herein for detection of multi-order market abuse can be incorporated within existing trade platforms. For example, an exemplary system as described herein can include market abuse detection for both insider dealing (e.g., checking for clients placing orders with a broker ahead of market news), and for direct market access (DMA) market abuse (e.g., checking for clients trading in a such a manner as to effect market prices, such as multi-order market abuse). That is, for example, systems and methods in accordance with the disclosed subject matter can include the use of a financial instrument's characteristic trade frequency in combination with other metrics to detect market abuse. Such other metrics can include, for example, a correlation coefficient between the limit prices and arrival times of trade orders in the sequence, the fraction of sequence order volume filled, and/or the difference in percentage volume filled for the final order in the sequence and others in the sequence.

In exemplary embodiments of the disclosed subject matter, the techniques disclosed herein can be used to detect a variety of multiple order market abuse types, including “ramping” and “spoofing & layering.” For example, in connection with ramping (i.e., entering orders into an electronic trading system at prices which are higher than the previous bid or lower than the previous offer, and withdrawing them before they are executed), the techniques disclosed herein can identify a series of unfilled orders from the same counterparty for the same instrument placed within the spread in a short period of time. The limit price of these orders can trend upward for a series of buy orders and downward for a series of sell orders. A list of orders can be scanned for a sequence of orders in the same direction with limit prices inside the spread. Once the sequence is identified, scores can be calculated for the average time between orders compared to the average trade rate for the instrument, the correlation coefficient between the limit prices and arrival times of the orders in the sequence, and the fraction of sequence order volume filled.

For purposes of illustration, and not limitation, for ramping to be successful it generally takes place on a timescale faster than the rate at which the instrument trades. The score for the average time between orders compared to the average trade rate for the instrument can be generated as shown in Table 1, using the one or more processors, where T_{S} is the average time between orders in the series and T_{M} is the average time between trades on the market.

TABLE 1

| Avg. time between orders in the | Score |
|---|---|
| sequence (T_{S}) vs. Avg. time between | (market abuse |
| trades on the market (T_{M}) | likelihood) |
| T_{S} < 5% of T_{M} | Very High |
| T_{S} < 10% of T_{M} | High |
| T_{S} < 15% of T_{M} | Medium |
| T_{S} < 20% of T_{M} | Low |

In certain embodiments, the correlation coefficient between the limit prices and arrival times of the orders in the sequence can also be generated. The correlation coefficient can provide a measure of how strongly the order prices are trending with time. As an example, the correlation coefficient between two values can be generated by determining the covariance of those values, divided by the product of their standard deviations, as given below:

$${ρ}_{X , Y} = \frac{cov ( X , Y )}{{σ}_{X} {σ}_{Y}} = \frac{E [ ( X - {μ}_{X} ) ( Y - {μ}_{Y} )}{{σ}_{X} {σ}_{Y}} . \qquad ( 1 )$$

In this example, the correlation coefficient can take a value between −1 and 1 with the minimum value representing a perfect downward trend and the maximum being a perfect upward trend. As such, a sequence of buy orders with a positive correlation coefficient close to 1 would correspond to a likelihood of market abuse. For purposes of illustration, and not limitation, Table 2 provides an exemplary set of scores corresponding to likelihood of market abuse where ρ_{LT} is the correlation coefficient.

TABLE 2

| ρ_{LT} (for buy sequence) | Score (market abuse likelihood) |
|---|---|
| ρ_{LT} > 0.95 | Very High |
| ρ_{LT} > 0.90 | High |
| ρ_{LT} > 0.85 | Medium |
| ρ_{LT} > 0.80 | Low |
| ρ_{LT} (for sell sequence) | Score (market abuse likelihood) |
| ρ_{LT} < −0.95 | Very High |
| ρ_{LT} < −0.90 | High |
| ρ_{LT} < −0.85 | Medium |
| ρ_{LT} < −0.80 | Low |

Additionally, the fraction of sequence order volume filled can be generated. In connection with ramping, a client may attempt to move the touch price (i.e., the highest bid price or lowest offer price of a market maker for a financial instrument) without accumulating executions a low percentage of total sequence order volume filled. Accordingly, such abuse can be detected by assigning scores to the fraction of order volume filled for the sequence, such as shown as Table 3.

TABLE 3

| % order volume filled | Score (market abuse likelihood) |
|---|---|
| % Filled < 2% | Very High |
| % Filled < 5% | High |
| % Filled < 7% | Medium |
| % Filled < 10% | Low |

As another non-limiting example, in connection with “spoofing & layering” (i.e., the submission of multiple orders at different prices on one side of the order book, as buy, and the submission on the other side of the order book to sell, and following execution of the latter order, rapidly removing the multiple initial buy orders from the book (or vice versa for sell orders)), the techniques disclosed herein can include identifying a series of unfilled orders from the same counterparty for the same instrument placed within the spread in a short period of time. For example, the limit price of these orders can trend upward for a series of buy orders and downward for a series of sell orders, and the initial series of orders can be followed by an order in the opposite direction. A candidate sequence can be identified (e.g., a series of orders in one direction) followed by an order in the opposite direction. For sequences other than those for which the initial orders are not priced within the spread, scores can be generated for the average time between orders compared to the average trade rate for the instrument, the correlation coefficient between the limit prices and the arrival times of the orders in the sequences, excluding the final order, and the difference in percentage volume filled for the final order in the sequence and all others.

For example, as with ramping, spoofing & layering can involve placing orders on a timescale faster than the rate at which the instrument trades. As such, the instrument's characteristic trade frequency can be compared with the average time between trades in a sequence for a particular trade and can be scored as described above in Table 1. Likewise, a sequence of buy orders with a positive correlation coefficient can correspond to a likelihood of market abuse, and can be scored as described above in Table 2.

In connection with spoofing and layering, the final order in the sequence can represent the order which the abuser wishes to execute. Thus, in cases of spoofing and layering, the final order can be expected to have a higher proportion of its volume filled relative to the “dummy” orders previously placed. Accordingly, the difference in percentage volume filled for the final order in the sequence can be compared to prior orders in the sequence to generate a score corresponding to the likelihood of spoofing and layering market abuse. For example, the imbalance, Im, in proportion filled, can be determined by taking the difference in percentage filled values as follows:

$$Im = ( \frac{{\sum }_{i = 0}^{k - 1} {F}_{i}}{{\sum }_{i = 0}^{k - 1} {O}_{i}} - \frac{{F}_{k}}{{O}_{k}} ) \times 100 , \qquad ( 2 )$$

Where Im is the imbalance value, k is the number of orders in the sequence, Fi is the filled quantity of order i and Oi is the order quantity of order i. The imbalance value Im will be equal to 100% for a sequence where all but the final order are filled and −100% for a sequence where none but the final order are filled. As such exemplary scores corresponding to a likelihood of market abuse are provided in Table 4.

TABLE 4

| Imbalance value (Im) | Score (market abuse likelihood) |
|---|---|
| Im < −95% | Very High |
| Im < −90% | High |
| Im < −85% | Medium |
| Im < −80% | Low |

As described herein, the information about the sequence of trades of a financial instrument by a client can include a plurality of scores, each corresponding to a likelihood of multiple order market abuse. Such scores can be combined to further enhance the accuracy of a determination that a particular trade sequence involved market abuse. For example, the score corresponding to the average time between trade orders can be compared with the score corresponding to the correlation coefficient between the limit prices and arrival times of the orders in the sequence, the score corresponding to the fraction of sequence order volume filled, and/or the score corresponding to the difference in percentage volume filled for the final order in the sequence.

As described above in connection with certain embodiments, certain components, e.g., trader 110, broker 120, gateway 133, and broker 130 can include a computer or computers, processor, network, mobile device, cluster, or other hardware to perform various functions. Moreover, certain elements of the disclosed subject matter can be embodied in computer readable code which can be stored on computer readable media and which when executed can cause a processor to perform certain functions described herein. In these embodiments, the computer and/or other hardware play a significant role in permitting the system and method for the trading of financial instruments. For example, the presence of the computers, processors, memory, storage, and networking hardware provides the ability to detect market abuse using a financial instruments characteristic trade frequency.

Additionally, as described above in connection with certain embodiments, certain components can communicate with certain other components, for example via a network, e.g., the interne or an intranet. To the extent not expressly stated above, the disclosed subject matter is intended to encompass both sides of each transaction, including transmitting and receiving. One of ordinary skill in the art will readily understand that with regard to the features described above, if one component transmits, sends, or otherwise makes available to another component, the other component will receive or acquire, whether expressly stated or not.

The presently disclosed subject matter is not to be limited in scope by the specific embodiments herein. Indeed, various modifications of the disclosed subject matter in addition to those described herein will become apparent to those skilled in the art from the foregoing description and the accompanying figures. Such modifications are intended to fall within the scope of the appended claims.

1. A method for detecting multi-order market abuse in the trading of financial instruments using a direct market access gateway adapted to communicate an order from a client to an exchange, comprising:
monitoring a plurality of trade orders for a financial instrument placed by the client;
recording at least an arrival time of each of the plurality of trade orders;
processing the recorded arrival times of each of the plurality of trade orders to determine an average time between orders for at least one trade sequence within the plurality of trade orders; and
outputting information about the at least one trade sequence if the average time between orders is less than a predetermined percentage of a characteristic trade frequency of the financial instrument.

2. The method of claim 1, wherein the characteristic trade frequency of the financial instrument includes the average trade frequency of the financial instrument on the exchange.

3. The method of claim 2, wherein the predetermined percentage is less than five percent of the average trade frequency for the financial instrument on the exchange.

4. The method of claim 1, wherein the information about the at least one trade sequence includes a score corresponding to a likelihood of multiple order market abuse.

5. The method of claim 4, wherein the multiple order market abuse includes one or more of ramping, or spoofing and layering.

6. The method of claim 1, further comprising:
recording at least a limit price of each of the plurality of trade orders;
processing the recorded limit prices of each of the plurality of trade orders to determine a correlation coefficient between the limit prices and the recorded arrival times; and
outputting information about the at least one trade sequence if the correlation coefficient meets a predetermined criteria.

7. The method of claim 6, wherein the predetermined criteria is where the correlation coefficient is above a predetermined coefficient threshold for a buy sequence, and wherein the predetermined criteria is where the correlation coefficient is below a predetermined coefficient threshold for a sell sequence.

8. The method of claim 1, further comprising:
recording at least a fraction of order volume filled for the sequence; and
outputting information about the at least one trade sequence if the fraction of order volume filled meets a predetermined criteria.

9. The method of claim 8, further comprising:
processing the recorded fraction of order volume filled for the sequence to generate an imbalance metric; and
outputting information about the at least one trade sequence if the imbalance metric meets a predetermined criteria.

10. The method of claim 9, wherein generating the imbalance metric includes dividing a total filled quantity for each order in the sequence except a last order by a total order quantity of orders in the sequence except the last order quantity and subtracting the ratio of a filled quantity for the last order in the sequence over the last order quantity.

11. A non-transitory computer readable medium containing computer-executable instructions that when executed cause one or more computer devices to perform a method for detecting multi-order market abuse in the trading of financial instruments using a direct market access gateway adapted to communicate an order from a client to an exchange, comprising:
monitoring a plurality of trade orders for a financial instrument placed by the client;
recording at least an arrival time of each of the plurality of trade orders;
processing the recorded arrival times of each of the plurality of trade orders to determine an average time between orders for at least one trade sequence within the plurality of trade orders; and
outputting information about the at least one trade sequence if the average time between orders is less than a predetermined percentage of a characteristic trade frequency of the financial instrument.

12. The non-transitory computer-readable medium of claim 11, wherein the characteristic trade frequency of the financial instrument includes the average trade frequency of the financial instrument on the exchange.

13. The non-transitory computer-readable medium of claim 12, wherein the predetermined percentage is less than five percent of the average trade frequency for the financial instrument on the exchange.

14. The non-transitory computer-readable medium of claim 11, wherein the information about the at least one trade sequence includes a score corresponding to a likelihood of multiple order market abuse.

15. The non-transitory computer-readable medium of claim 14, wherein the multiple order market abuse includes one or more of ramping, or spoofing and layering.

16. The non-transitory computer-readable medium of claim 11, further comprising:
recording at least a limit price of each of the plurality of trade orders;
processing the recorded limit prices of each of the plurality of trade orders to determine a correlation coefficient between the limit prices and the recorded arrival times; and
outputting information about the at least one trade sequence if the correlation coefficient meets a predetermined criteria.

17. The non-transitory computer-readable medium of claim 16, wherein the predetermined criteria is where the correlation coefficient is above a predetermined coefficient threshold for a buy sequence, and wherein the predetermined criteria is where the correlation coefficient is below a predetermined coefficient threshold for a sell sequence.

18. The non-transitory computer-readable medium of claim 11, further comprising:
recording at least a fraction of order volume filled for the sequence; and
outputting information about the at least one trade sequence if the fraction of order volume filled meets a predetermined criteria.

19. The non-transitory computer-readable medium of claim 18, further comprising:
processing the recorded fraction of order volume filled for the sequence to generate an imbalance metric; and
outputting information about the at least one trade sequence if the imbalance metric meets a predetermined criteria.

20. The non-transitory computer-readable medium of claim 19, wherein generating the imbalance metric includes dividing a total filled quantity for each order in the sequence except a last order by a total order quantity of orders in the sequence except the last order quantity and subtracting the ratio of a filled quantity for the last order in the sequence over the last order quantity.

21. A system for detecting multi-order market abuse in the trading of financial instruments using a direct market access gateway adapted to communicate an order from a client to an exchange, comprising:
one or more memories adapted to store a plurality of trade orders for a financial instrument placed by the client and to store at least an arrival time of each of the plurality of trade orders;
one or more processors, coupled with the one or more memories,
configured to process the stored arrival times of each of the plurality of trade orders to determine an average time between orders for at least one trade sequence within the plurality of trade orders, and configured to generate information about the at least one trade sequence if the average time between orders is less than a predetermined percentage of a characteristic trade frequency of the financial instrument; and
an output, coupled with the one or more processors, adapted to output the information about the at least one trade sequence.

22. The system of claim 21, wherein the one or more processors is further configured to determine the characteristic trade frequency of the financial instrument by determining the average trade frequency of the financial instrument on the exchange.

23. The system of claim 22, wherein the predetermined percentage is less than five percent of the average trade frequency for the financial instrument on the exchange.

24. The system of claim 21, wherein the information about the at least one trade sequence includes a score corresponding to a likelihood of multiple order market abuse.

25. The system of claim 24, wherein the multiple order market abuse includes one or more of ramping, or spoofing and layering.

26. The system of claim 21, wherein the one or more memories are further adapted to store at least a limit price of each of the plurality of trade orders; and wherein the one or more processors are further configured to process stored limit prices of each of the plurality of trade orders to determine a correlation coefficient between the limit prices and the recorded arrival times, and configured to generate information about the at least one trade sequence if the correlation coefficient meets a predetermined criteria.

27. The system of claim 26, wherein the predetermined criteria is where the correlation coefficient is above a predetermined coefficient threshold for a buy sequence, and wherein the predetermined criteria is where the correlation coefficient is below a predetermined coefficient threshold for a sell sequence.

28. The system of claim 21, wherein the one or more memories are further adapted to store at least a fraction of order volume filled for the sequence and wherein the one or more processors are further configured to output information about the at least one trade sequence if the fraction of order volume filled meets a predetermined criteria.

29. The system of claim 28, wherein the one or more processors are further configured to process the stored fraction of order volume filled for the sequence to generate an imbalance metric and output information about the at least one trade sequence if the imbalance metric meets a predetermined criteria.

30. The system of claim 29, wherein generating the imbalance metric includes dividing a total filled quantity for each order in the sequence except a last order by a total order quantity of orders in the sequence except the last order quantity and subtracting the ratio of a filled quantity for the last order in the sequence over the last order quantity.
